(19) United States
(12) Patent Application Publication
(10) Pub. No.: US 2013/0202969 A1
(43) Pub. Date: Aug. 8, 2013

(54) METHOD FOR PRODUCING ANODE MATERIAL, ANODE MATERIAL, METHOD FOR PRODUCING LITHIUM SECONDARY BATTERY, AND LITHIUM SECONDARY BATTERY

(71) Applicants: Tomoya Matsunaga, Susono-shi (JP); Hideki Nakayama, Susono-shi (JP); Makio Kon, Mishima-shi (JP); Aoi Takano, Susono-shi (JP)

(72) Inventors: Tomoya Matsunaga, Susono-shi (JP); Hideki Nakayama, Susono-shi (JP); Makio Kon, Mishima-shi (JP); Aoi Takano, Susono-shi (JP)

(73) Assignee: TOYOTA JIDOSHA KABUSHIKI KAISHA, Toyota-shi, Achi-ken (JP)

(21) Appl. No.: 13/809,558

(22) PCT Filed: Apr. 28, 2011
(86) PCT No.: PCT/JP2011/060455

§ 371 Date: Mar. 11, 2013

(30) Foreign Application Priority Data
Jul. 15, 2010 (JP) 2010-160400

(51) Int. Cl. H01M 4/1397; H01M 4/04; H01M 10/0525; H01M 10/058; H01M 10/04; H01M 4/136

(52) U.S. Cl. CPC H01M 4/1397; H01M 10/04; H01M 4/136; H01M 10/0525; H01M 10/058; H01M 4/049
USPC 429/231.6; 29/623.5; 423/647; 252/503

(57) ABSTRACT

A main object of the present invention is to provide a method for producing an anode material which enhances the reversibility of the conversion reaction and the cycle characteristics of lithium secondary batteries. The object is attained by providing a method for producing an anode material that is used in a lithium secondary battery, comprising a mechanical milling step of micronizing a raw material composition containing MgH₂ by mechanical milling.

### TECHNICAL FIELD

The present invention relates to a method for producing an anode material utilizing a conversion reaction.

### BACKGROUND ART

Along with the rapid distribution of information-related devices and communication devices such as personal computers, video cameras and mobile telephones in recent years, development of batteries that are utilized as the power sources have been emphasized. Furthermore, even in the automotive industry and the like, development of high-output power and high-capacity batteries for electric cars or hybrid cars is underway. Currently, among various batteries, lithium batteries are attracting the public attention from the viewpoint of having a high energy density.

Known anode active materials that are used in lithium batteries comprise conversion-based anode active materials which are metal hydrides (MHₓ). As an example of the conversion-based anode active materials, Patent Literature 1 describes MgH₂. Furthermore, Patent Literature 1 discloses a method for synthesizing MgH₂ by using Mg as a starting raw material, micronizing the raw material by a ball mill method, and subjecting Mg to a hydrogen treatment in a high pressure hydrogen atmosphere. Non Patent Literature 1 also discloses the use of MgH₂ as an active material for lithium batteries. The electrochemical behavior in the case of using MgH₂ as an active material is as follows.

During charging: MgH₂+2Li⁺+2e⁻→Mg+2LiH (Reaction Formula 1)

During discharging: Mg+2LiH→MgH₂+2Li⁺+2e⁻ (Reaction Formula 2)

### CITATION LIST

### Patent Literature

Patent Literature 1: US 2008/0286652 A

### Non Patent Literature

Non Patent Literature 1: Oumellal, Y et al., “Metal hydrides for lithium-ion batteries”, Nature Materials, Vol. 7, 916-921 (2008)

### SUMMARY OF INVENTION

### Technical Problem

MgH₂ has a problem that the reversibility of the conversion reaction is low. Specifically, there is a problem that the reaction of the reaction formula (2) does not easily occur as compared with the reaction of the reaction formula (1). Furthermore, MgH₂ has a problem that the cycle characteristics are poor. The present invention was achieved in view of such circumstances, and it is a main object of the present invention to provide a method for producing an anode material, which enhances the reversibility of the conversion reaction and the cycle characteristics of lithium secondary batteries.

### Solution to Problem

In order to solve the problems described above, the present invention provides a method for producing an anode material that is used in a lithium secondary battery, comprising a mechanical milling step of micronizing a raw material composition containing MgH₂ by mechanical milling.

According to the present invention, when a raw material composition containing MgH₂, which is an active material, is micronized by mechanical milling, the particle size of MgH₂ can be made small, and the reversibility of the conversion reaction can be enhanced. As a result, the charge-discharge efficiency of lithium secondary batteries can be increased. Furthermore, according to the present invention, when the particle size of MgH₂ is made small, disconnection of the electrical conduction paths (Li ion conduction path and electron conduction path) that comes with fine pulverization resulting from charging and discharging, can be suppressed, and the cycle characteristics of lithium secondary batteries can be enhanced.

In regard to the invention described above, it is preferable to comprise a hydrogen absorption and desorption step in which the material obtained by the mechanical milling step is micronized by absorption and desorption of hydrogen in a gas phase. It is because when micronization by absorption and desorption of hydrogen (chemical micronization) is carried out after the micronization by mechanical milling (mechanical micronization), the particles can be further micronized.

Furthermore, according to the present invention, there is provided a method for producing an anode material that is used in a lithium secondary battery, and the method comprises steps of: a mechanical milling step of micronizing a raw material composition containing Mg by mechanical milling; and a hydrogen absorption and desorption step of micronizing the material obtained in the mechanical milling step, by means of absorption and desorption of hydrogen in a gas phase.

According to the present invention, when a raw material composition containing Mg is micronized by mechanically milling, and then is further micronized by absorption and desorption of hydrogen, MgH₂ having a small particle size can be obtained, and thus the reversibility of the conversion reaction can be enhanced. As a result, the charge-discharge efficiency of lithium secondary batteries can be increased. Furthermore, according to the present invention, when the particle size of MgH₂ is made small, disconnection of the electrical conduction paths (Li ion conduction path and electron conduction path) that comes with fine pulverization resulting from charging and discharging can be suppressed, and the cycle characteristics of lithium secondary batteries can be enhanced.

Furthermore, in the present invention, there is provided a method for producing an anode material that is used in a lithium secondary battery, comprising a hydrogen absorption and desorption step of micronizing a material containing Mg or MgH₂ by absorption and desorption of hydrogen in a gas phase.

According to the present invention, when a material containing Mg or MgH₂ is subjected to absorption and desorption of hydrogen, MgH₂ having a small particle size can be obtained, and the reversibility of the conversion reaction can be enhanced. As a result, the charge-discharge efficiency of lithium secondary batteries can be increased. Furthermore, according to the present invention, when the particle size of MgH₂ is made small, disconnection of the electrical conduction paths (Li ion conduction path and electron conduction path) that comes with fine pulverization resulting from charging and discharging, can be suppressed, and the cycle characteristics of lithium secondary batteries can be enhanced.

In regard to the invention described above, it is preferable that the average particle size of the MgH₂-containing particles obtained after the hydrogen absorption and desorption step be in the range of 50 nm to 150 nm. When the average particle size of the MgH₂-containing particles obtained after hydrogen absorption and desorption step is adjusted to the range described above, disconnection of the electrical conduction paths that comes with fine pulverization resulting from charging and discharging, can be effectively suppressed, and an enhancement of the cycle characteristics of lithium secondary batteries can be promoted.

In regard to the invention described above, it is preferable that the raw material composition or the material containing Mg or MgH₂, further contain at least one of a conductive material, and a metal catalyst which enhances the reversibility of the conversion reaction. It is because when a conductive material is added, an anode material having satisfactory electron conductibility can be obtained, and when a metal catalyst is added, the reversibility of the conversion reaction can be further enhanced.

Furthermore, in the present invention, there is provided an anode material that is used in a lithium secondary battery, and that contains MgH₂-containing particles, with the average particle size of the MgH₂-containing particles being in the range of 50 nm to 150 nm.

According to the present invention, when the average particle size of the MgH₂-containing particles is in the range described above, the reversibility of the conversion reaction can be enhanced. As a result, the charge-discharge efficiency of lithium secondary batteries can be increased. Furthermore, when the average particle size of the MgH₂-containing particles is in the range described above, disconnection of the electrical conduction paths that comes with fine pulverization resulting from charging and discharging, can be effectively suppressed, and an enhancement of the cycle characteristics of lithium secondary batteries can be promoted.

Furthermore, in the present invention, there is provided a method for producing a lithium secondary battery which comprises a cathode layer, an anode layer, and an electrolyte layer formed between the cathode layer and the anode layer, characterized in that the method comprises an anode layer forming step of forming the anode layer by using an anode material obtained by the above-mentioned method for producing an anode material.

According to the present invention, a lithium secondary battery having satisfactory reversibility of the conversion reaction and satisfactory cycle characteristics can be obtained by using the anode material obtained by the production method described above.

Furthermore, in the present invention, there is provided a lithium secondary battery comprising a cathode layer, an anode layer, and an electrolyte layer formed between the cathode layer and the anode layer, characterized in that the anode layer contains an anode material containing MgH₂-containing particles, and the anode material is a material that has been subjected to absorption and desorption of hydrogen in a gas phase.

According to the present invention, a lithium secondary battery having satisfactory reversibility of the conversion reaction and satisfactory cycle characteristics can be obtained by using an anode material which contains MgH₂-containing particles and has been subjected to absorption and desorption of hydrogen in a gas phase.

### Advantageous Effects of Invention

In the present invention, there is obtained an effect that an anode material which improves the reversibility of the conversion reaction and the cycle characteristics of lithium secondary batteries can be obtained.

### BRIEF DESCRIPTION OF DRAWINGS

FIGS. 1A and 1B are each a flow chart illustrating the method for producing an anode material of the present invention.

FIG. 2 is a flow chart illustrating a conventional method for producing MgH₂.

FIG. 3 is a flow chart illustrating the method for producing an anode material of the present invention.

FIG. 4 is a flow chart illustrating the method for producing an anode material of the present invention.

FIG. 5 is a flow chart illustrating the method for producing an anode material of the present invention.

FIG. 6 is a schematic cross-sectional diagram illustrating an example of the lithium secondary battery of the present invention.

FIGS. 7A and 7B are each a flow chart explaining the operations of Example 2 and Comparative Example 1.

FIG. 8 is a SEM photograph of the anode material obtained in Example 2.

FIG. 9 is a SEM photograph of the anode material obtained in Comparative Example 1.

FIG. 10 illustrates the results for a charge-discharge characteristics evaluation of batteries for evaluation which use the anode materials obtained in Example 2 and Comparative Example 1.

FIGS. 11A and 11B are each a flow chart explaining the operations of Examples 3 and 4, and Reference Examples 1 to 4.

FIG. 12 illustrates the results for the measurement of the average particle size of the anode materials obtained in Examples 3 and 4, and Reference Examples 1 to 4.

FIG. 13 illustrates the results for a cycle characteristics evaluation of batteries for evaluation which use the anode materials obtained in Examples 3 and 4 and Reference Example 4.

### DESCRIPTION OF EMBODIMENTS

Hereinafter, the method for producing an anode material, the anode material, the method for producing a lithium secondary battery, and the lithium secondary battery of the present invention will be described in detail.

A. Method for Producing Anode Material

First, the method for producing an anode material of the present invention will be described. The method for producing an anode material of the present invention can be classified into three embodiments. The method for producing an anode material of the present invention will be described separately as a first embodiment, a second embodiment, and a third embodiment.

### 1. First Embodiment

The method for producing an anode material of the first embodiment is a method for producing an anode material that is used in a lithium secondary battery, and the method comprises a mechanical milling step of micronizing a raw material composition containing MgH₂ by mechanical milling.

According to the first embodiment, when a raw material composition containing MgH₂, which is an active material, is micronized by mechanical milling, the particle size of MgH₂ can be made small, and the reversibility of the conversion reaction can be enhanced. As a result, the charge-discharge efficiency of lithium secondary batteries can be increased. It has not been known hitherto how the particle size of MgH₂ would affect the reversibility the conversion reaction. The inventors of the present invention found that making the particle size of MgH₂ small is very effective for an enhancement of the reversibility of the conversion reaction, and thus completed the present invention. It is contemplated that when the particle size of MgH₂ is decreased, the reversibility of the conversion reaction is enhanced because if the particle size of MgH₂ is decreased, the specific surface area increases, and the reaction of the reaction formula (2) can easily occur. Furthermore, it is contemplated that when the particle size of MgH₂ is decreased, the Li diffusion path is shortened, and the reactivity is enhanced. There is also an advantage that when the particle size of MgH₂ is decreased, overvoltage is reduced in the Li absorption reaction (of the reaction formula (1)).

Furthermore, according to the first embodiment, when the particle size of MgH₂ is decreased, disconnection of electrical conduction paths (Li ion conduction path and electron conduction path) that comes with fine pulverization resulting from charging and discharging, can be effectively suppressed, and an enhancement of the cycle characteristics of lithium secondary batteries can be enhanced. Here, when a lithium secondary battery is produced by using an anode material containing MgH₂, there are occasions in which fine pulverization of MgH₂ contained in the anode layer proceeds along with the charging and discharging of the battery, electrical conduction paths are disconnected, and cycle deterioration occurs. In contrast to this, by sufficiently micronizing MgH₂, disconnection of electrical conduction paths that comes with fine pulverization resulting from charging and discharging can be effectively suppressed. As a result, the cycle characteristics of lithium secondary batteries can be enhanced.

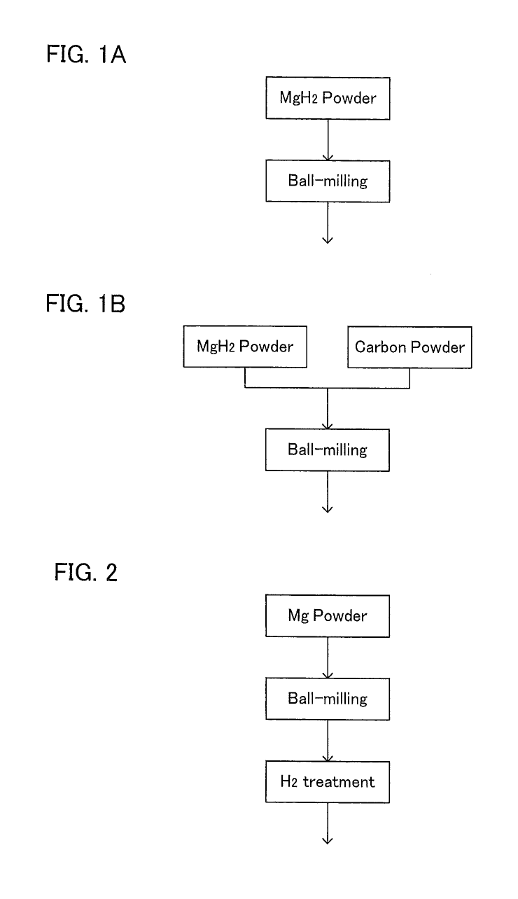

FIGS. 1A and 1B are each a flow chart illustrating the method for producing an anode material of the first embodiment. In FIG. 1A, first, a MgH₂ powder which is an active material is used as a raw material composition. Next, the raw material composition is subjected to ball milling, and the raw material composition is micronized. Thereby, an anode material can be obtained. On the other hand, in FIG. 1B, first, a MgH₂ powder which is an active material, and a carbon powder which is a conductive material are provided, and a raw material composition is obtained by mixing these powders at a predetermined ratio. Next, the raw material composition is subjected to ball milling, and the raw material composition is micronized. Thereby, an anode material can be obtained.

FIG. 2 is a flow chart explaining a conventional method for producing MgH₂. As illustrated in FIG. 2, conventionally, a Mg powder is subjected to ball milling to thereby micronize the Mg powder, and subsequently, the micronized Mg powder is subjected to a hydrogen treatment in a hydrogen atmosphere under high pressure. Thus, MgH₂ is obtained. The MgH₂ obtained by such a method has a large particle size, and has poor reversibility of the conversion reaction. In contrast to this, in the first embodiment, the reversibility of the conversion reaction can be enhanced by subjecting MgH₂ to further micronization.

Hereinafter, various steps of the method for producing an anode material of the first embodiment will be described.

(1) Mechanical Milling Step

Mechanical milling step according to the first embodiment is a process for micronizing a raw material composition containing MgH₂ by mechanical milling.

The raw material composition for the first embodiment contains at least MgH₂, and may further contain at least one of a conductive material and a metal catalyst that enhances the reversibility of the conversion reaction. MgH₂ according to the first embodiment is usually a material which functions as an active material, and when MgH₂ reacts with Li ion, LiH and Mg are generated. Furthermore, Mg (zero-valent) produced by the reaction with Li ion further causes an alloying reaction with Li ion, and occludes Li until Li₃Mg₇ is formed. As such, although a very large Li absorption capacity can be obtained with MgH₂, since the reverse reaction (particularly, the reaction of the reaction formula (2)) does not easily occur, there is a problem that the charge-discharge efficiency is lowered. In the first embodiment, this problem is solved by micronizing the raw material composition containing MgH₂.

The content of MgH₂ in the raw material composition is not particularly limited, but for example, the content is preferably 40% by weight or greater, and more preferably in the range of 60% by weight to 98% by weight.

Furthermore, the raw material composition according to the first embodiment may further include a conductive material. It is because an anode material having satisfactory electron conductibility can be obtained. There are no particular limitations on the conductive material, but examples thereof include carbon materials such as mesocarbon microbeads (MCMB), acetylene black, Ketjen black, carbon black, cokes, carbon fibers, and graphite.

The content of the conductive material in the raw material composition is not particularly limited, but for example, the content is preferably in the range of 1% by weight to 60% by weight, and more preferably in the range of 2% by weight to 40% by weight. It is because if the proportion of the conductive material is too small, there is a possibility that electron conductibility cannot be sufficiently enhanced; and if the proportion of the conductive material is too large, the proportion of MgH₂ becomes relatively smaller, and there is a possibility that there may be a large decrease in capacity.

Furthermore, the raw material composition according to the first embodiment may further contain a metal catalyst that enhances the reversibility of the conversion reaction. By adding the metal catalyst, for example, the reaction of the reaction formula (2) can be promoted, and the reversibility of the conversion reaction can be enhanced. Furthermore, it is contemplated that, for example, in order to promote the reaction of the reaction formula (2), a reaction of hydrogen detachment from LiH (dissociation reaction of LiH) and a reaction of hydrogen addition to Mg become important, and the metal catalyst promotes any one or both of the reactions.

The metal catalyst is not particularly limited as long as the catalyst can enhance the reversibility of the conversion reaction, but for example, the catalyst is preferably a catalyst which causes dissociation of LiH, or a catalyst which is capable of dissociation and adsorption of H₂ gas. Meanwhile, the “catalyst which is capable of dissociation and adsorption of H₂ gas” means both a catalyst which dissociates and adsorbs H₂ gas, and a catalyst which adsorbs hydrogen before the hydrogen that has been detached from LiH becomes hydrogen gas.

Furthermore, it is preferable that the metal catalyst according to the first embodiment have a transition metal element. This is because it is speculated that the 3d orbital, 4d orbital, 4f orbital and the like of transition metal elements enhance the reversibility of the conversion reaction. Furthermore, the possibility that these orbitals may contribute significantly to the dissociation of LiH and the dissociation and adsorption of H₂ gas, can also be considered. The transition metal element is not particularly limited as long as the element is classified as a transition metal element in the Periodic Table of Elements, but among other, the transition metal element is preferably at least one selected from the group consisting of Ti, V, Cr, Mn, Co, Ni, Zr, Nb, Pd, La, Ce and Pt. It is because the reversibility of the conversion reaction can be enhanced to a large extent. Furthermore, examples of the type of the metal catalyst in the first embodiment include a simple metal substance, an alloy, and a metal oxide. Particularly, the metal catalyst according to the first embodiment is preferably a simple Ni substance or a Ni alloy.

The proportion of the metal catalyst based on MgH₂ is not particular limited, but the proportion is preferably a proportion that can enhance the reversibility of the conversion reaction of lithium secondary batteries as compared with the case where a metal catalyst is not used. The proportion of the metal catalyst with respect of MgH₂ is, for example, preferably in the range of 0.1 at % to 10 at %, and more preferably in the range of 0.5 at % to 6 at %. It is because if the proportion of the metal catalyst is too small, there is a possibility that the reversibility of the conversion reaction may not be sufficiently enhanced, and if the proportion of the metal catalyst is too large, the proportion of MgH₂ is relatively small, and there is a possibility that a large decrease in the capacity may occur. Meanwhile, the proportion of the metal catalyst with respect to MgH₂ can be determined by SEM-EDX.

In mechanical milling step according to the first embodiment, micronization of a raw material composition is carried out by mechanical milling. Mechanical milling is a method of pulverizing a sample while applying mechanical energy. Furthermore, by performing micronization by mechanical milling, the particles of various materials that are included in the raw material composition are vigorously brought into contact. Thereby, the various material contained in the raw material composition are more markedly micronized than simple micronization (for example, micronization using a mortar). Furthermore, by performing micronization by mechanical milling, a conductive material and a metal catalyst can be uniformly dispersed on the surface of MgH₂ particles. Examples of the mechanical milling in the first embodiment include ball milling, vibratory milling, turbo milling, and disk milling. Among these, ball milling is preferred, and particularly planetary ball milling is preferred.

Furthermore, various conditions of mechanical milling are set so as to obtain a desired anode material. For example, in the case of producing an anode material by planetary ball milling, a raw material composition and pulverizing balls are placed in the pot, and the raw material composition is treated at a predetermined speed of rotation for a predetermined time. The speed of platform rotation employed at the time of performing planetary ball milling is, for example, in the range of 100 rpm to 1000 rpm, and above all, the speed is preferably in the range of 200 rpm to 600 rpm. Furthermore, the treatment time employed at the time of performing planetary ball milling is, for example, in the range of 1 hour to 100 hours, and above all, the treatment time is preferably in the range of 2 hours to 10 hours. Furthermore, in the first embodiment, it is preferable to perform mechanical milling such that the various materials contained in the raw material composition have predetermined average particle sizes.

The MgH₂-containing particles obtainable by mechanical milling step are preferably further micronized. It is because when the particle size of the MgH₂-containing particles is made small, the reversibility of the conversion reaction can be further enhanced. The MgH₂-containing particles refer to MgH₂ particles, or particles in which other materials (a conductive material, a metal catalyst, and the like) are dispersed on the surface of MgH₂ particles. The average particle size of the MgH₂-containing particles is, for example, preferably 2 μm or less, and more preferably in the range of 0.1 μm to 1 μm. Meanwhile, the average particle size of the MgH₂-containing particles can be calculated by measuring the particle sizes of MgH₂-containing particles (n=100) by SEM (scanning electron microscopy) observation, and determining the average. Furthermore, when the average particle size of the MgH₂-containing particles differ greatly from the average particle sizes of other materials, the average particle size (d₅₀) of the MgH₂-containing particles may be determined by a particle size distribution analysis. Also, as will be described below, the average particle size of the MgH₂-containing particles can be determined by a gas adsorption test.

The conductive material obtainable by mechanical milling step is preferably further micronized. It is because a more micronized conductive material can further contribute to an enhancement of electron conduction. The average particle size of the conductive material is, for example, preferably 2 μm or less, and more preferably in the range of 0.1 μm to 1 μm. Meanwhile, the average particle size of the conductive material can be determined by SEM observation and a particle size distribution analysis, as described above.

The metal catalyst obtainable by mechanical milling step is preferably further micronized. It is because when the particle size of the metal catalyst is made small, the reversibility of the conversion reaction can be further enhanced. The average particle size of the metal catalyst is, for example, preferably 1 μm or less, and more preferably in the range of 10 nm to 500 nm. Meanwhile, the average particle size of the metal catalyst can be determined by SEM observation and a particle size distribution analysis, as described above.

(2) Hydrogen Absorption and Desorption Step

In the first embodiment, it is preferable to include the hydrogen absorption and desorption step of micronizing the material obtained in the mechanical milling step by absorption and desorption of hydrogen in a gas phase. It is because when absorption and desorption of hydrogen is carried out, the particles can be micronized, and the reversibility of the conversion reaction can be enhanced. As a result, the charge-discharge efficiency of lithium secondary batteries can be increased. Furthermore, by micronizing the particles, disconnection of electrical conduction paths (Li ion conduction path and electron conduction path) that comes with fine pulverization resulting from charging and discharging can be suppressed, and the cycle characteristics of lithium secondary batteries can be enhanced. Furthermore, when micronization by absorption and desorption of hydrogen (chemical micronization) is carried out after micronization by mechanical milling (mechanical micronization), the MgH₂-containing particles can be further micronized. In the first embodiment, it is preferable to attain a state in which hydrogen has been absorbed into magnesium (that is, magnesium being in a state in which the function as an active material can be exhibited) by the hydrogen absorption and desorption step.

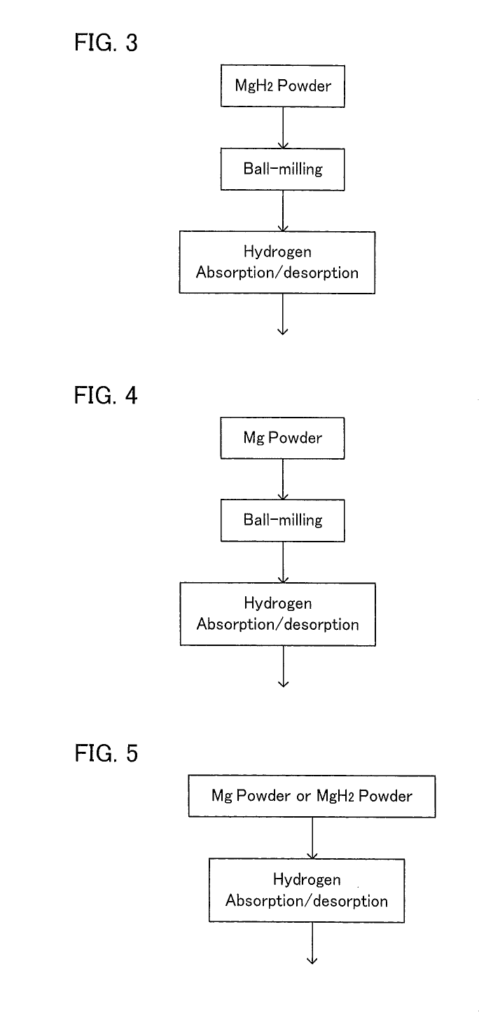

FIG. 3 is a flow chart illustrating the method for producing an anode material of the first embodiment. In FIG. 3, first, a MgH₂ powder which is an active material is used as a raw material composition. Next, the raw material composition is subjected to ball milling to be micronized. Next, the micronized raw material composition is subjected to absorption and desorption of hydrogen in a gas phase. Thereby, an anode material can be obtained.

In the hydrogen absorption and desorption step, further micronization of the particles is attempted by subjecting MgH₂ in the MgH₂-containing particles to absorption and desorption of hydrogen by means of a gas phase. Furthermore, in the first embodiment, since the raw material composition contains MgH₂, usually, the treatment is carried out in the order of hydrogen desorption and hydrogen absorption.

The method of desorbing hydrogen is not particularly limited, but for example, a method of reducing the pressure may be used. In the first embodiment, it is preferable to reduce the pressure and to further perform heating. The pressure at the time of reducing the pressure is not particularly limited as long as it is a pressure lower than the atmospheric pressure, but for example, the pressure is preferably 1 kPa or less, and more preferably 0.1 kPa or less. Particularly, in the first embodiment, it is preferable to desorb hydrogen in a vacuum condition (a condition at 1 Pa or less). Furthermore, the heating temperature at the time of hydrogen desorption is, for example, preferably in the range of 200° C. to 400° C., and more preferably in the range of 250° C. to 350° C. Furthermore, the treatment time for hydrogen desorption is, for example, preferably in the range of 1 minute to 300 minutes, and more preferably in the range of 5 minutes to 120 minutes. On the other hand, the method of absorbing hydrogen is not particularly limited, but for example, a method of pressurizing in a hydrogen gas atmosphere may be used. In the first embodiment, it is preferable to apply pressure and to further perform heating. The pressure at the time of pressurization is not particularly limited as long as it is a pressure higher than the Mg—MgH₂ equilibrium pressure at the temperature at which hydrogen is absorbed. For example, if the temperature at which hydrogen is absorbed is 300° C., the pressure is preferably 0.01 MPa or higher, more preferably in the range of 0.01 MPa to 10 MPa, and even more preferably in the range of 0.1 MPa to 1 MPa. Meanwhile, preferred ranges of the heating temperature at the time of hydrogen absorption and the treatment time of hydrogen absorption are the same as in the case of hydrogen desorption. Furthermore, the number of operations to carry out the absorption and desorption of hydrogen is not particularly limited as long as the number is one time or more, but for example, the number of operations is preferably in the range of 2 to 100 times, and more preferably in the range of 2 to 30 times.

Furthermore, the average particle size of the MgH₂-containing particles obtained after hydrogen absorption and desorption step is not particularly limited as long as it is smaller than the average particle size of the MgH₂-containing particles obtained after mechanical milling step, but for example, the average particle size is preferably in the range of 50 nm to 150 nm, more preferably in the range of 50 nm to 100 nm, even more preferably in the range of 50 nm to 85 nm, and particularly preferably in the range of 50 nm to 70 nm. It is because when the average particle size of the MgH₂-containing obtained after the hydrogen absorption and desorption step is adjusted to the range described above, disconnection of electrical conduction paths that comes with fine pulverization resulting from charging and discharging can be effectively suppressed, and an enhancement of the cycle characteristics can be promoted.

The average particle size of the MgH₂-containing particles obtained after hydrogen absorption and desorption step can be determined by a gas adsorption test. Specifically, the average particle size is measured by a nitrogen gas adsorption method by using AUTOSORB-1™ manufactured by Yuasa Ionics Co., Ltd. The specific surface area is calculated by the BET method, and the average particle size is determined by using the specific surface area thus obtained. Meanwhile, it is assumed that the MgH₂-containing particles are spheres. In the measurement according to a nitrogen gas adsorption method, for example, a vacuum degassing treatment is carried out before the measurement at 60° C. for 12 hours, and the measurement is made at 77 K.

### 2. Second Embodiment

Next, the method for producing an anode material of the second embodiment will be explained. The method for producing an anode material of the second embodiment is a method for producing an anode material used in a lithium secondary battery, and the method comprises steps of: a mechanical milling step of micronizing a raw material composition containing Mg by mechanical milling; and a hydrogen absorption and desorption step of micronizing the material obtained by the mechanical milling step by absorption and desorption of hydrogen in a gas phase.

According to the second embodiment, when a raw material composition containing Mg is micronized by mechanical milling, and is subsequently micronized by absorption and desorption of hydrogen, MgH₂ having a small particle size can be obtained, and the reversibility of the conversion reaction can be enhanced. As a result, the charge-discharge efficiency of lithium secondary batteries can be increased. Furthermore, according to the second embodiment, when the particle size of MgH₂ is made small, disconnection of electrical conduction paths (Li ion conduction path and electron conduction path) that comes with fine pulverization resulting from charging and discharging can be suppressed, and the cycle characteristics of lithium secondary batteries can be enhanced.

FIG. 4 is a flow chart illustrating the method for producing an anode material of the second embodiment. In FIG. 4, first, a Mg powder is prepared into a raw material composition. Next, the raw material composition is subjected to ball milling and to be micronized. Next, the micronized raw material composition is subjected to absorption and desorption of hydrogen in a gas phase. Thereby, an anode material can be obtained.

Hereinafter, various steps of the method for producing an anode material of the second embodiment will be described.

(1) Mechanical Milling Step

Mechanical milling step in the second embodiment is a process for micronizing a raw material composition containing Mg by mechanical milling.

The content of Mg in the raw material composition is not particularly limited, but for example, the content is preferably 40% by weight or greater, and more preferably in the range of 60% by weight to 98% by weight. Furthermore, the raw material composition according to the second embodiment may further contain a conductive material and a metal catalyst that enhances the reversibility of the conversion reaction. In regard to these descriptions, conditions of mechanical milling, and other terms, the same matters as those described in the first embodiment apply in this embodiment, and therefore, further descriptions are omitted herein.

The Mg-containing particles obtainable by mechanical milling step are preferably further micronized. It is because when the particle size of the Mg-containing particles is made small, the reversibility of the conversion reaction can be further enhanced. The Mg-containing particles refer to Mg particles, or particles in which other materials (a conductive material, a metal catalyst, and the like) are dispersed on the surface of Mg particles. The average particle size of the Mg-containing particles is, for example, preferably 2 μm or less, and more preferably in the range of 0.1 μm to 1 μm. Meanwhile, the method for measuring the average particle size of the Mg-containing particles is similar to the case of the MgH₂-containing particles as described above. Furthermore, in regard to the average particle sizes of the conductive material and the metal catalyst obtainable by mechanical milling step, the same matters as described in the first embodiment also apply.

(2) Hydrogen Absorption and Desorption Step

Hydrogen absorption and desorption step in the second embodiment is a process for micronizing the material obtained by the mechanical milling step, by absorption and desorption of hydrogen in a gas phase. When absorption and desorption of hydrogen is carried out, particles can be micronized, and the reversibility of the conversion reaction can be enhanced. As a result, the charge-discharge efficiency of lithium secondary batteries can be increased. Furthermore, by micronizing the particles, disconnection of electrical conduction paths (Li ion conduction path and electron conduction path) that comes with fine pulverization resulting from charging and discharging can be suppressed, and the cycle characteristics of lithium secondary batteries can be enhanced. Furthermore, when micronization by absorption and desorption of hydrogen (chemical micronization) is carried out after the micronization by mechanical milling (mechanical micronization), the Mg-containing particles can be further micronized. In the second embodiment, it is preferable to attain a state in which hydrogen has been absorbed into magnesium (that is, magnesium being in a state in which the function as an active material can be exhibited) by the hydrogen absorption and desorption step.

In hydrogen absorption and desorption step, further micronization of the particles is attempted by subjecting Mg in the Mg-containing particles to absorption and desorption of hydrogen by means of a gas phase. Furthermore, in the second embodiment, since the raw material composition contains Mg, usually, the treatment is carried out in the order of hydrogen desorption and hydrogen absorption. In regard to the method for the absorption and desorption of hydrogen, the average particle size of MgH₂-containing particles obtained after hydrogen absorption and desorption step, and other terms, the same matters as those described in the first embodiment apply, and therefore, further descriptions are omitted herein.

### 3. Third Embodiment

Next, the method for producing an anode material of the third embodiment will be explained. The method for producing an anode material of the third embodiment is a method for producing an anode material that is used in a lithium secondary battery, and comprises a hydrogen absorption and desorption step of micronizing a material containing Mg or MgH₂ by absorption and desorption of hydrogen in a gas phase.

According to the third embodiment, when a material containing Mg or MgH₂ is subjected to absorption and desorption of hydrogen, MgH₂ having a small particle size can be obtained, and the reversibility of the conversion reaction can be enhanced. As a result, the charge-discharge efficiency of lithium secondary batteries can be increased. Furthermore, according to the third embodiment, when the particle size of MgH₂ is made small, disconnection of electrical conduction paths (Li ion conduction path and electron conduction path) that comes with fine pulverization resulting from charging and discharging can be suppressed, and the cycle characteristics can be enhanced.

FIG. 5 is a flow chart illustrating the method for producing an anode material of the third embodiment. In FIG. 5, first, a Mg powder or a MgH₂ powder is used. Next, such a powder is subjected to absorption and desorption of hydrogen in a gas phase. Thereby, an anode material can be obtained.

Hydrogen absorption and desorption step according to the third embodiment is a process for micronizing a material containing Mg or MgH₂ by absorption and desorption of hydrogen in a gas phase. When absorption and desorption of hydrogen is carried out, particles can be micronized, and the reversibility of the conversion reaction can be enhanced. As a result, the charge-discharge efficiency of lithium secondary batteries can be increased. Furthermore, by micronizing the particles, disconnection of electrical conduction paths (Li ion conduction path and electron conduction path) that comes with fine pulverization resulting from charging and discharging can be suppressed, and the cycle characteristics of lithium secondary batteries can be enhanced. The “material containing Mg or MgH₂” is not particularly limited as long as the material contains at least Mg or MgH₂, and the material may be a material composed of Mg particles only, a material composed of MgH₂ particles only, or may be a material in which other materials (a conductive material, a metal catalyst, or the like) are dispersed on the surface of Mg particles or MgH₂ particles. Furthermore, the material may further contain at least one of a conductive material and a metal catalyst, in addition to Mg or MgH₂. Particularly, in the third embodiment, it is preferable that the material containing Mg or MgH₂ have been micronized by any arbitrary method. It is because the reversibility of the conversion reaction can be further enhanced. Furthermore, in the third embodiment, it is preferable to attain a condition in which hydrogen has been absorbed into magnesium (that is, being in a state in which the function as an active material can be exhibited) by the hydrogen absorption and desorption step.

In the hydrogen absorption and desorption step, further micronization of the particles is attempted by subjecting Mg or MgH₂ to absorption and desorption of hydrogen or desorption and absorption of hydrogen by means of a gas phase. In regard to the method for absorption and desorption of hydrogen, the average particle size of MgH₂-containing particles obtained after the hydrogen absorption and desorption step, and other terms, the same matters as those described in the first embodiment apply, and therefore, further descriptions are omitted herein.

B. Anode Material

Next, the anode material of the present invention will be described. The anode material of the present invention is an anode material that is used in a lithium secondary battery and contains MgH₂-containing particles, and the average particle size of the MgH₂-containing particles is in the range of 50 nm to 150 nm.

According to the present invention, when the average particle size of the MgH₂-containing particles is in the range described above, the reversibility of the conversion reaction can be enhanced. As a result, the charge-discharge efficiency of lithium secondary batteries can be increased. Furthermore, when the average particle size of the MgH₂-containing particles is in the range described above, disconnection of electrical conduction paths that comes with fine pulverization resulting from charging and discharging can be effectively suppressed, and the cycle characteristics of lithium secondary batteries can be promoted.

Furthermore, it is preferable that the MgH₂-containing particles according to the present invention be particles in which at least one of a conductive material and a metal catalyst be dispersed on the surface of MgH₂ particles (composite material). In regard to the conductive material and the metal catalyst, the same matters as those described in the above section “A. Method for producing anode material” apply, and therefore, further descriptions are omitted herein. Furthermore, in regard to the preferred average particle size of MgH₂-containing particles and other terms, the same matters as those described in the above section “A. Method for producing anode material” also apply. In the present invention, a lithium secondary battery characterized by containing the anode material described above in an anode layer, can be provided.

C. Method for Producing Lithium Secondary Battery

Next, the method for producing a lithium secondary battery of the present invention will be described. The method for producing a lithium secondary battery of the present invention is a method for producing a lithium secondary battery which comprises a cathode layer, an anode layer, and an electrolyte layer that is formed between the cathode layer and the anode layer, characterized in that the method comprises an anode layer forming step of forming the anode layer by using the anode material obtained by the method for producing an anode material described above.

According to the present invention, a lithium secondary battery having satisfactory reversibility of the conversion reaction and satisfactory cycle characteristics can be obtained by using the anode material obtained by the production method described above. Meanwhile, in regard to the method for producing the anode material used in the present invention, the same matters as those described in the above section “A. Method for producing anode material” apply. Furthermore, it is preferable that the anode material used in the present invention be a material obtained by performing at least a process of hydrogen absorption and desorption. When the anode material is subjected to absorption and desorption of hydrogen in a gas phase before charging and discharging of the battery, disconnection of electrical conduction paths that comes with fine pulverization resulting from charging and discharging can be suppressed, and the cycle characteristics can be enhanced.

An example of the method for forming an anode layer may be a method of applying an anode layer forming composition containing at least an anode material. Also, the method for forming other layers is the same as the layer forming method used in a general method for producing a lithium secondary battery, and therefore, further descriptions are omitted herein.

D. Lithium Secondary Battery

Next, the lithium secondary battery of the present invention will be described. The lithium secondary battery of the present invention is a lithium secondary battery comprising a cathode layer, an anode layer, and an electrolyte layer that is formed between the cathode layer and the anode layer, characterized in that the anode layer has an anode material containing MgH₂-containing particles, while the anode material is a material which has been subjected to absorption and desorption of hydrogen in a gas phase.

According to the present invention, a lithium secondary battery having satisfactory reversibility of the conversion reaction and satisfactory cycle characteristics can be obtained by using an anode material which contains MgH₂-containing particles and has been subjected to absorption and desorption of hydrogen in a gas phase. Furthermore, according to the present invention, when the anode material is subjected to absorption and desorption of hydrogen in a gas phase before charging and discharging of the battery, disconnection of electrical conduction paths that comes with fine pulverization resulting from charging and discharging can be suppressed, and the cycle characteristics can be enhanced.

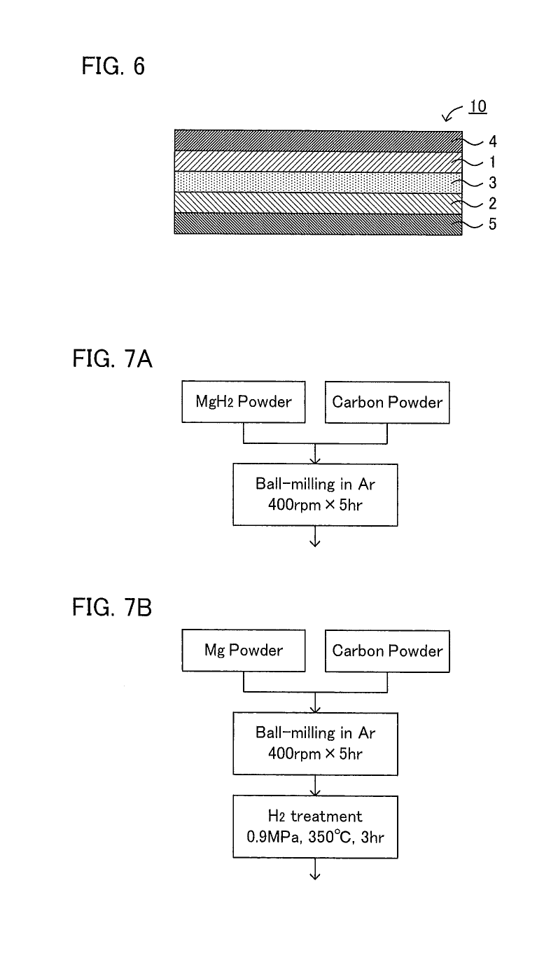

FIG. 6 is a schematic cross-sectional diagram illustrating an example of the lithium secondary battery of the present invention. The lithium secondary battery 10 in FIG. 6 comprises a cathode layer 1, an anode layer 2, an electrolyte layer 3 that is formed between the cathode layer 1 and the anode layer 2, a cathode current collector 4 that collects electricity of the cathode layer 1, and an anode current collector 5 that collects electricity of the anode layer 2. In the present invention, the anode layer 2 contains an anode material that contains MgH₂-containing particles, and the anode material is a material which has been subjected to absorption and desorption of hydrogen in a gas phase.

Hereinafter, various configurations of the lithium secondary battery of the present invention will be described.

1. Anode Layer

First, the anode layer according to the present invention will be described. The anode layer according to the present invention is a layer containing at least an anode layer containing MgH₂-containing particles. Furthermore, this anode material is usually a material which has been subjected to absorption and desorption of hydrogen in a gas phase. In the hydrogen absorption and desorption step of absorbing and desorbing hydrogen in a gas phase, the same matters as those described in the above section “A. Method for producing anode material” apply, and therefore, further descriptions are omitted herein. Furthermore, in regard to the preferred average particle size of MgH₂-containing particles in the anode material, and other terms, the same matters as described in the above section “A. Method for producing anode material” apply. The content of the anode material in the anode layer is not particularly limited, but for example, the content is preferably 20% by weight or greater, and more preferably in the range of 40% by weight to 80% by weight.

The anode layer may further contain at least any one of a conductive material and a binder material. As discussed above, the anode material itself may contain a conductive material, but the conductive material contained in the anode material and the conductive material that is newly added may be the same material, or may be different materials. Meanwhile, specific examples of the conductive material are as described above. Furthermore, examples of the binder material include fluorine-containing binder materials such as polyvinylidene fluoride (PVDF). The thickness of the anode layer is, for example, preferably in the range of 0.1 μm to 1000 μm.

2. Cathode Layer

Next, the cathode layer according to the present invention will be described. The cathode layer according to the present invention is a layer which contains at least a cathode active material. Examples of the cathode active material include lamellar cathode active materials such as LiCoO₂, LiNiO₂, LiCo_{1/3}Ni_{1/3}Mn_{1/3}O₂, LiVO₂, and LiCrO₂; spinel type cathode active materials such as LiMn₂O₄, Li(Ni_{0.25}Mn_{0.75})₂O₄, LiCoMnO₄, and Li₂NiMn₃O₈; and olivine type cathode active materials such as LiCoPO₄, LiMnPO₄, and LiFePO₄. The content of the cathode active material in the cathode layer is not particularly limited, but for example, the content is preferably in the range of 40% by weight to 99% by weight.

The cathode layer according to the present invention may further contain at least a conductive material and a binder material. In regard to the conductive material and the binder material, the same matters as those described in the above section “1. Anode layer” apply, and therefore, further descriptions are omitted herein. The thickness of the cathode layer is, for example, preferably in the range of 0.1 μm to 1000 μm.

3. Electrolyte Layer

Next, the electrolyte layer according to the present invention will be described. The electrolyte layer according to the present invention is a layer that is formed between the cathode layer and the anode layer. Li ion conduction between the cathode active material and the anode active material is conducted via the electrolyte contained in the electrolyte layer. The form of the electrolyte layer is not particularly limited, and examples thereof include a liquid electrolyte layer, a gel electrolyte layer, and a solid electrolyte layer.

The liquid electrolyte layer is usually a layer that is formed by using a nonaqueous liquid electrolyte. The nonaqueous liquid electrolyte usually contains a metal salt and a nonaqueous solvent. Examples of the metal salt include inorganic lithium salts such as LiPF₆, LiBF₄, LiClO₄ and LiAsF₆; and organic lithium salts such as LiCF₃SO₃, LiN(CF₃SO₂)₂, LiN(C₂F₅SO₂)₂, and LiC(CF₃SO₂)₃. Examples of the nonaqueous solvent include ethylene carbonate (EC), propylene carbonate (PC), dimethyl carbonate (DMC), diethyl carbonate (DEC), ethyl methyl carbonate (EMC), butylene carbonate (BC), γ-butyrolactone, sulfolane, acetonitrile, 1,2-dimethoxymethane, 1,3-dimethoxypropane, diethyl ether, tetrahydrofuran, 2-methyltetrahydrofuran, and mixtures thereof. The concentration of the metal salt in the nonaqueous liquid electrolyte is, for example, in the range of 0.5 mol/L to 3 mol/L. Meanwhile, in the present invention, for example, a low-volatile liquid such as an ionic liquid may also be used as the nonaqueous liquid electrolyte. Furthermore, a separator may also be disposed between the cathode layer and the anode layer.

The thickness of the electrolyte layer may vary greatly depending on the type of the electrolyte and the configuration of the battery, but for example, the thickness is preferably in the range of 0.1 μm to 1000 μm, and above all, preferably in the range of 0.1 μm to 300 μm.

4. Other Configuration

The lithium secondary battery of the present invention may further comprise a cathode current collector that collects electricity of the cathode layer, and an anode current collector that collects electricity of the anode layer. Examples of the material of the cathode current collector include SUS, aluminum, nickel, iron, titanium, and carbon. On the other hand, examples of the material of the anode current collector include SUS, copper, nickel, and carbon. Furthermore, as the battery case used in the present invention, a general battery case for a lithium secondary battery can be used. Examples of the battery case include a battery case made of SUS. Furthermore, the lithium secondary battery of the present invention is preferably used as, for example, a battery for automotive vehicles. Examples of the shape of the lithium secondary battery of the present invention include a coin shape, a laminate shape, a cylinder shape, and a rectangular shape.

Meanwhile, the present invention is not intended to the limited to the embodiments described above. The embodiments are for illustrative purposes, and any embodiment that has substantially the same constitution as the technical idea described in the claims of the present invention and provides the same operating effect, is included in the technical scope of the present invention.

### EXAMPLES

Hereinafter, the present invention will be more specifically described by way of Examples.

### Example 1

A MgH₂ powder (average particle size 30 μm) was provided and was prepared into a raw material composition. Subsequently, in an Ar atmosphere, the raw material composition and zirconia balls for crushing (φ=10 mm) were introduced into a container for planetary ball milling such that the weight ratio of the raw material composition:zirconia ball for crushing was 1:40, and the container was sealed. Thereafter, the container was attached to a planetary ball mill apparatus, and micronization was carried out under the conditions of a speed of platform rotation of 400 rpm and a treatment time of 5 hours. Thereby, an anode material was obtained. In the anode material thus obtained, the average particle size of the MgH₂ powder was 0.5 μm.

### Example 2

FIG. 7A is a flow chart explaining the operations of Example 2. First, in addition to the MgH₂ powder used in Example 1, a carbon powder (MCMB, average particle size 1 μm) was provided. Meanwhile, this carbon powder was obtained by subjecting a commercially available MCMB (average particle size 20 μm) to a planetary ball milling treatment (400 rpm×5 hours). Subsequently, the MgH₂ powder and the carbon powder were mixed such that the weight ratio of MgH₂ powder:carbon powder would be 90:10, and a raw material composition was obtained. An anode material was obtained in the same manner as in Example 1, except that the raw material composition thus obtained was used. For the anode material thus obtained, the average particle size of the MgH₂ powder was 0.5 μm, and the average particle size of the carbon powder was 0.1 μm.

### Comparative Example 1

FIG. 7B is a flow chart explaining the operations of Comparative Example 1. First, a Mg powder (average particle size 30 μm) and the carbon powder used in Example 2 were provided. Subsequently, the Mg powder and the carbon powder were mixed such that the weight ratio of Mg powder:carbon powder would be 90:10, and thus a raw material composition was obtained. Subsequently, in an Ar atmosphere, the raw material composition and zirconia balls for crushing (φ=10 mm) were introduced into a container for planetary ball milling such that the weight ratio of the raw material composition:zirconia ball for crushing was 1:40, and the container was sealed. Thereafter, the container was attached to a planetary ball mill apparatus, and micronization was carried out under the conditions of a speed of platform rotation of 400 rpm and a treatment time of 5 hours. Thereafter, hydrogenation was carried out under the conditions of a hydrogen pressure of 0.9 MPa, 350° C. and 3 hours, and thus an anode material was obtained.

### [Evaluation 1]

(SEM Observation)

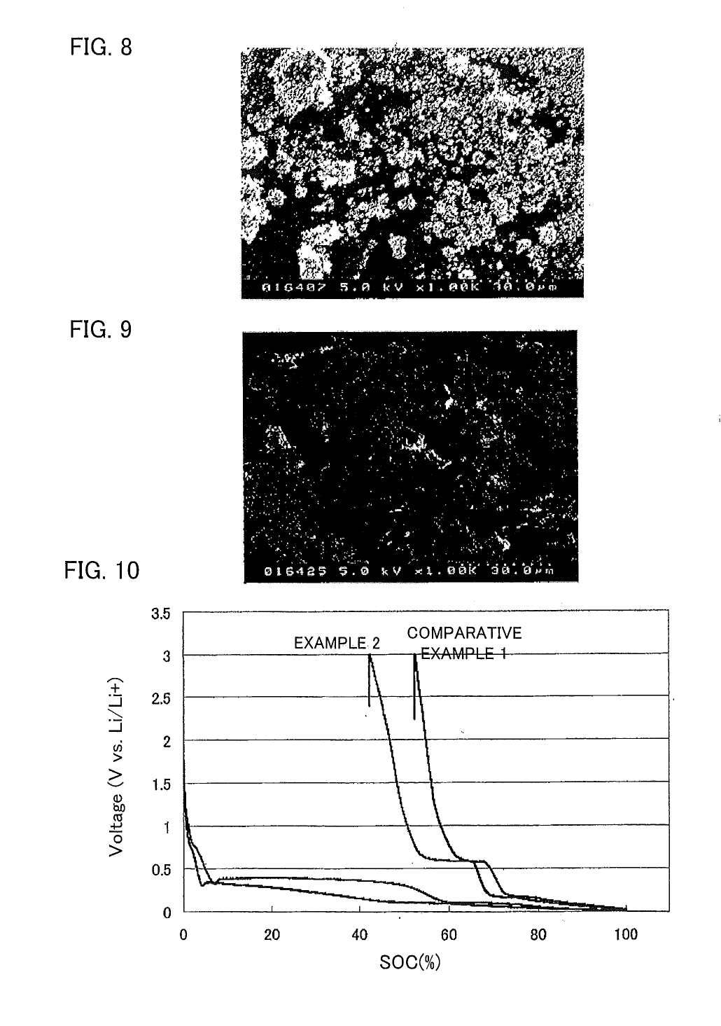

SEM observation of the anode materials obtained in Example 2 and Comparative Example 1 was carried out. The results are presented in FIG. 8 and FIG. 9. As illustrated in FIG. 8, it could be confirmed the anode material of Example 2 had small particle sizes of the MgH₂ powder and the carbon powder. In contrast to this, as illustrated in FIG. 9, the anode material of Comparative Example 1 had large particle sizes of the MgH₂ powder and the carbon powder.

(Battery Evaluation)

Batteries for evaluation were produced by using the anode materials obtained in Example 2 and Comparative Example 1. First, an anode material obtained by the method described above, a conductive material (acetylene black 60 wt %+VGCF 40 wt %), and a binder material (polyvinylidene fluoride, PVDF) were mixed at a weight ratio of anode material:conductive material:binder material=45:40:15, and the mixture was kneaded to obtain a paste. Subsequently, the paste thus obtained was applied on a copper foil with a doctor blade, dried and pressed, and thereby, a test electrode having a thickness of 10 μm was obtained.

Thereafter, a CR2032 type coin cell was used; the test electrode was used as a working electrode; Li metal was used as an opposite electrode; and a porous separator of polyethylene/polypropylene/polyethylene was employed as a separator. Furthermore, a liquid electrolyte prepared by dissolving LiPF₆ as a supporting salt at a concentration of 1 mol/L in a solvent prepared by mixing ethylene carbonate (EC), dimethyl carbonate (DMC) and ethyl methyl carbonate (EMC) at a volume ratio of EC:DMC:EMC=3:3:4, was used. A battery for evaluation was obtained by using these.

The batteries for evaluation thus obtained was charged and discharged at a battery evaluation environment temperature of 25° C. and a current rate of C/50. The voltage rage was 0.01 V to 3.0 V. The results are presented in Table 1 and FIG. 10.

TABLE 1

| | Li | Li | Charge- |
|---|---|---|---|
| | absorption | desorption | discharge |
| | capacity | capacity | efficiency |
| | (mAh/g) | (mAh/g) | η (%) |
| Example 2 | 3020 | 1742 | 57.7 |
| Comparative | 2719 | 1290 | 47.4 |
| Example 1 | | | |

As illustrated in Table 1 and FIG. 10, it was confirmed that the charge-discharge efficiency was increased by conducting micronization by mechanical milling.

### Example 3

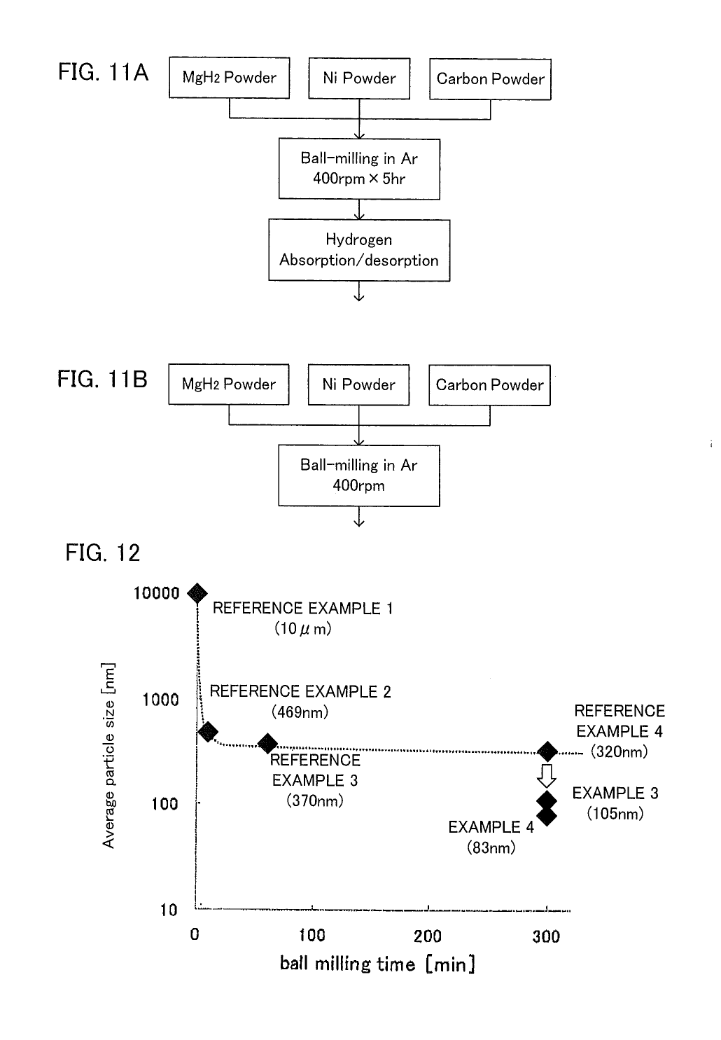

FIG. 11A is a flow chart explaining the operations of Example 3. First, a MgH₂ powder (average particle size 10 μm), a Ni powder (average particle size 100 nm) as a metal catalyst, and a carbon powder (MCMB, average particle size 1 μm) were provided. Meanwhile, this carbon powder was a powder obtained by subjecting a commercially available MCMB (average particle size 20 μm) to a planetary ball milling treatment (400 rpm×5 hours). Subsequently, the Ni powder was added at a proportion of 3 at % with respect to the MgH₂ powder. Thereafter, the MgH₂ powder, the Ni powder and the carbon powder were mixed such that the weight ratio of (MgH₂ powder+Ni powder):carbon powder would be 90:10, and thus a raw material composition was obtained. Subsequently, in an Ar atmosphere, the raw material composition and zirconia balls for crushing (φ=10 mm) were introduced into a container for planetary ball milling such that the weight ratio of the raw material composition: zirconia ball for crushing was 1:40, and the container was sealed. Thereafter, the container was attached to a planetary ball mill apparatus, and micronization was carried out under the conditions of a speed of platform rotation of 400 rpm and a treatment time of 5 hours.

Thereafter, the material thus obtained was subjected to two cycles of a hydrogen absorption and desorption treatment. The conditions for the hydrogen absorption and desorption treatment were as follows. Meanwhile, the hydrogen absorption and desorption treatment was started from hydrogen desorption.
Conditions for hydrogen desorption: 300° C., vacuum, 1 hour
Conditions for hydrogen absorption: 300° C., hydrogen pressure 0.88 MPa, 0.5 hours

As such, an anode material was obtained.

### Example 4

An anode material was obtained in the same manner as in Example 3, except that the hydrogen absorption and desorption treatment was changed from 2 cycles to 5 cycles.

### Reference Examples 1 to 4

FIG. 11B is a flow chart explaining the operations of Reference Examples 1 to 4. In Reference Examples 1 to 4, anode materials were obtained in the same manner as in Example 3, except that the treatment time for ball milling was changed, and the hydrogen absorption and desorption treatment was not carried out. Meanwhile, in Reference Examples 1 to 4, the treatment time for ball milling was set to 0 minute, 10 minutes, 60 minutes, and 300 minutes, respectively.

### [Evaluation 2]

(Measurement and Evaluation of Average Particle Size)

For the anode materials obtained in Examples 3 and 4 and Reference Examples 1 to 4, the specific surface areas were respectively measured by using AUTOSORB, and the average particle sizes of the MgH₂-containing particles were determined from the values. Meanwhile, the method for determining the average particle size was as described above. The results are presented in FIG. 12. As illustrated in FIG. 12, in the ball milling treatment, the average particle size was about 300 nm, but it was found that the average particle size can be adjusted to about 100 nm or less by the hydrogen absorption and desorption treatment, and further micronization can be carried out.

(Battery Evaluation)

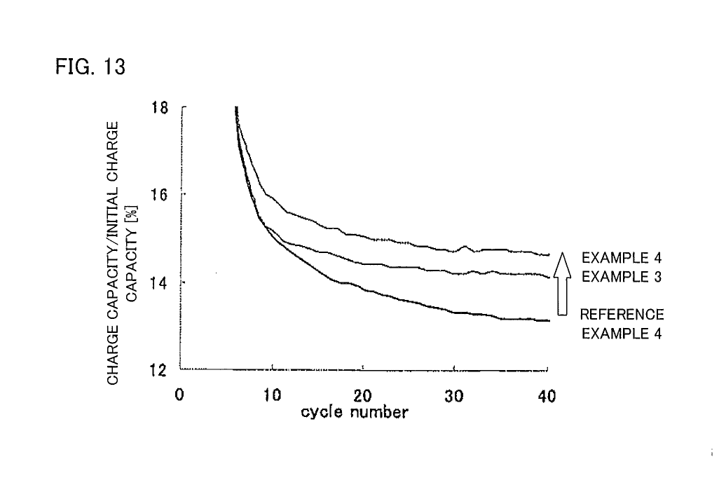

Batteries for evaluation were obtained by the same method as the method described in Evaluation 1 by using the anode materials obtained in Examples 3 and 4 and Reference Example 4. The batteries for evaluation thus obtained were subjected to charging and discharging (voltage range: 0.01 V to 3.0 V) at a battery evaluation environment temperature of 25° C. and a current rate of C/50, and the initial charge-discharge capacity was determined. Thereafter, the current rate was set to C/10, charging and discharging (voltage range: 0.01 V to 3.0 V) was repeated, and the charge-discharge capacity for each cycle was determined. The results of charging capacity relative to the initial charging capacity are presented in FIG. 13. As illustrated in FIG. 13, Examples 3 and 4 exhibited more satisfactory cycle characteristics as compared with Reference Example 4. This is speculated to be because disconnection of electrical conduction paths that comes with fine pulverization resulting from charging and discharging could be suppressed by micronizing the anode material in advance by absorbing and desorbing hydrogen in a gas phase.

### REFERENCE SIGNS LIST

1 Cathode layer
2 Anode layer
3 Electrolyte layer
4 Cathode current collector
5 Anode current collector
10 Lithium secondary battery

1. (canceled)

2. A method for producing an anode material that is used in a lithium secondary battery, comprising:
a mechanical milling step of micronizing a raw material composition containing MgH₂ by mechanical milling, and
a hydrogen absorption and desorption step of micronizing a material obtained by the mechanical milling step by absorption and desorption of hydrogen in a gas phase.

3. A method for producing an anode material that is used in a lithium secondary battery, comprising:
a mechanical milling step of micronizing a raw material composition containing Mg by mechanical milling; and
a hydrogen absorption and desorption step of micronizing a material obtained by the mechanical milling step by absorption and desorption of hydrogen in a gas phase.

4. A method for producing an anode material that is used in a lithium secondary battery, comprising:
a hydrogen absorption and desorption step of micronizing a material containing Mg or MgH₂ by absorption and desorption of hydrogen in a gas phase.

5. The method for producing an anode material according to claim 2, wherein an average particle size of a MgH₂-containing particle obtained after the hydrogen absorption and desorption step is in the range of 50 nm to 150 nm.

6. The method for producing an anode material according to claim 2, wherein the raw material composition or the material contains Mg or MgH₂ further contains at least one of a conductive material and a metal catalyst that enhances reversibility of conversion reaction.

7. An anode material that is used in a lithium secondary battery, wherein
the anode material contains a MgH₂-containing particle, and
an average particle size of the MgH₂-containing particle is in the range of 50 nm to 150 nm.

8. A method for producing a lithium secondary battery comprising a cathode layer, an anode layer, and an electrolyte layer formed between the cathode layer and the anode layer, wherein the method comprises an anode layer forming step of forming the anode layer by using an anode material obtained by the method for producing an anode material according to claim 2.

9. A lithium secondary battery comprising a cathode layer, an anode layer, and an electrolyte layer formed between the cathode layer and the anode layer, wherein
the anode layer has an anode material containing a MgH₂-containing particle, and
the anode material is a material that has been subjected to absorption and desorption of hydrogen in a gas phase.

10. The method for producing an anode material according to claim 3, wherein an average particle size of a MgH₂-containing particle obtained after the hydrogen absorption and desorption step is in the range of 50 nm to 150 nm.

11. The method for producing an anode material according to claim 4, wherein an average particle size of a MgH₂-containing particle obtained after the hydrogen absorption and desorption step is in the range of 50 nm to 150 nm.

12. The method for producing an anode material according to claim 3, wherein the raw material composition or the material contains Mg or MgH₂ further contains at least one of a conductive material and a metal catalyst that enhances reversibility of conversion reaction.

13. The method for producing an anode material according to claim 4, wherein a raw material composition or the material contains Mg or MgH₂ further contains at least one of a conductive material and a metal catalyst that enhances reversibility of conversion reaction.

14. A method for producing a lithium secondary battery comprising a cathode layer, an anode layer, and an electrolyte layer formed between the cathode layer and the anode layer, wherein the method comprises an anode layer forming step of forming the anode layer by using an anode material obtained by the method for producing an anode material according to claim 3.

15. A method for producing a lithium secondary battery comprising a cathode layer, an anode layer, and an electrolyte layer formed between the cathode layer and the anode layer, wherein the method comprises an anode layer forming step of forming the anode layer by using an anode material obtained by the method for producing an anode material according to claim 4.
